(19) United States
(12) Patent Application Publication
(10) Pub. No.: US 2017/0196176 A1
(43) Pub. Date: Jul. 13, 2017

(54) HIGH DENSITY INDOOR FARMING APPARATUS, SYSTEM AND METHOD

(71) Applicant: Jack Griffin, Philadelphia, PA (US)

(72) Inventor: Jack Griffin, Philadelphia, PA (US)

(21) Appl. No.: 15/472,106

(22) Filed: Mar. 28, 2017

Related U.S. Application Data
(63) Continuation-in-part of application No. 15/088,894, filed on Apr. 1, 2016.
(60) Provisional application No. 62/345,621, filed on Jun. 3, 2016.
(60) Provisional application No. 62/128,294, filed on Mar. 4, 2015.

(51) Int. Cl. A01G 31/06; A01G 7/04

(52) U.S. Cl. CPC A01G 31/06; A01G 7/045; A01G 2031/006

(57) ABSTRACT

The disclosure is directed to providing a readily scalable hydroponic and vertical farming apparatus, system and method that remedies the foregoing issues, that is available in limited space and at high density, such as in urban areas, that presents low farming costs, and that improves crop yield and health.

### CROSS-REFERENCE TO RELATED APPLICATIONS

The present invention claims priority to U.S. Provisional Application No. 62/345,621, filed Jun. 3, 2016, and is a continuation in part of U.S. patent application Ser. No. 15/088,894, filed Apr. 1, 2016, which claims benefit of U.S. Provisional Application No. 62/128,294, filed Mar. 4, 2015, in the entireties of which are incorporated by reference herein as if fully set forth herein.

### BACKGROUND

Field of the Invention

The present disclosure is directed generally to farming, and more particularly is directed to high density indoor farming apparatuses, systems and methods.

Background of the Disclosure

Hydroponic farming, and/or so-called “vertical farming,” is well known in the present state of the art. However, the current states of these types of farming suffer from a variety of issues. These issues include a lack of sufficient density for the farming, which leads to a need to stack farming levels in vertical farms to too great an extent, insufficient or improper lighting, the need the clean hydroponic systems on a too frequent basis, and a lack of crop health, among many other issues.

Thus, the need exists for readily scalable indoor farming generally, and more particularly a scalable hydroponic and vertical farming apparatus, system and method that remedies the foregoing issues, that is available in limited space, such as in urban areas, that presents low farming costs, and that improves crop yield and health.

### SUMMARY OF THE DISCLOSURE

The disclosure is directed to providing a readily scalable hydroponic and vertical farming apparatus, system and method that remedies the foregoing issues, that is available in limited space and at high density, such as in urban areas, that presents low farming costs, and that improves crop yield and health.

### BRIEF DESCRIPTION OF THE FIGURES

The present disclosure is illustrated by way of example and not limitation in the figures of the accompanying drawings, in which like references indicate similar elements and in which:

FIG. 1 shows an embodiment of the disclosure;

FIG. 2 shows an embodiment of the disclosure;

FIG. 3 shows an embodiment of the disclosure;

FIGS. 4A and 4B show embodiments of the disclosure; and

FIGS. 5A and 5B show embodiments of the disclosure;

FIG. 6 shows an embodiment of the disclosure;

FIGS. 7A and 7B illustrate embodiments of the disclosure;

FIG. 8 illustrates an embodiment of the disclosure;

FIG. 9 illustrates an embodiment of the disclosure;

FIG. 10 illustrates an embodiment of the disclosure;

FIGS. 11A, 11B and 11C illustrate embodiments of the disclosure; and

FIG. 12 illustrates an embodiment of the disclosure.

### DETAILED DESCRIPTION

It is to be understood that the figures and descriptions of the present disclosure have been simplified to illustrate elements that are relevant for a clear understanding of the discussed embodiments, while eliminating, for the purpose of clarity, many other elements found in known apparatuses, systems, and methods. Those of ordinary skill in the art may thus recognize that other elements and/or steps are desirable and/or required in implementing the disclosure. However, because such elements and steps are known in the art, and because they consequently do not facilitate a better understanding of the disclosure, for the sake of brevity a discussion of such elements and steps is not provided herein. Nevertheless, the disclosure herein is directed to all such elements and steps, including all variations and modifications to the disclosed elements and methods, known to those skilled in the art.

Exemplary embodiments are provided so that this disclosure will be thorough, and will fully convey the scope to those who are skilled in the art. Numerous specific details are set forth, such as examples of specific components, devices, and methods, to enable a thorough understanding of embodiments of the present disclosure. It will be apparent to those skilled in the art that specific details need not be employed, that is, that the exemplary embodiments may be embodied in many different forms and thus should not be construed to limit the scope of the disclosure. For example, in some exemplary embodiments, well-known processes, well-known device structures, and well-known technologies are not described in detail.

The terminology used herein is for the purpose of describing particular example embodiments only and is thus not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

As to the methods discussed herein, the method steps, processes, and operations described herein are not to be construed as necessarily requiring their performance in the particular order discussed or illustrated, unless specifically identified as having an order of performance. It is also to be understood that additional or alternative steps may be employed.

When an element or layer is referred to as being “on”, “atop”, “engaged to”, “connected to,” “coupled to,” or a like term or phrase with respect to another element or layer, it may be directly on, engaged, connected or coupled to the other element or layer, or intervening elements or layers may be present. In contrast, when an element is referred to as being “directly on,” “directly engaged to”, “directly connected to”, “directly atop”, or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

The various exemplary embodiments will be described herein below with reference to the accompanying drawings. In the following description and the drawings, well-known functions or constructions are not shown or described in detail since they may obscure the disclosed embodiments with the unnecessary detail.

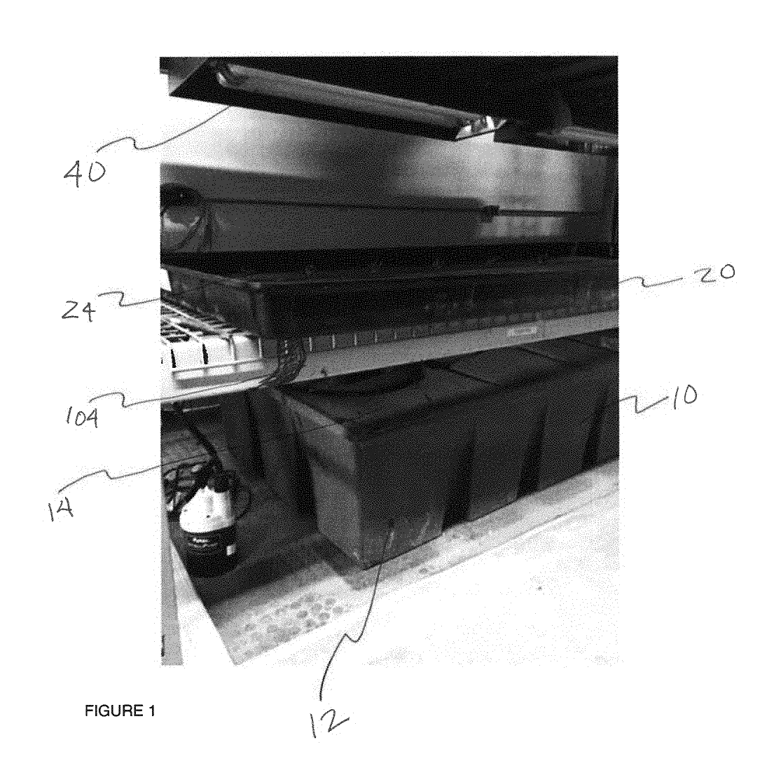

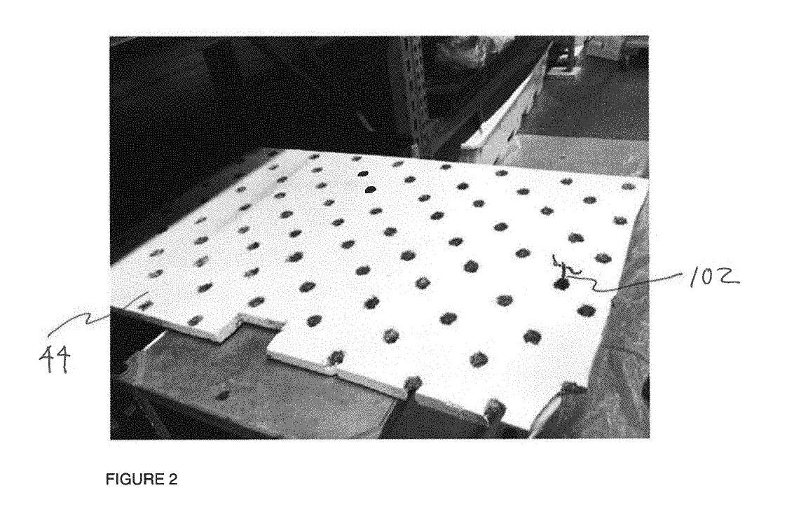

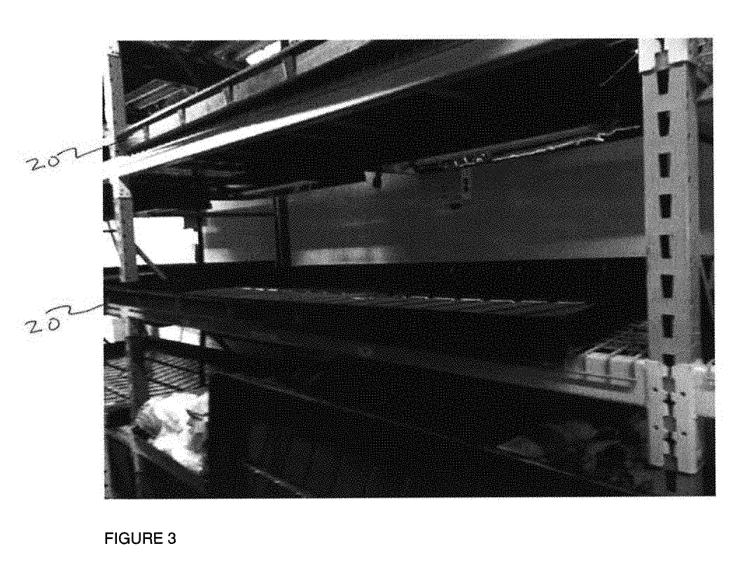

The present invention is and includes an apparatus, system, and method for high density farming. The referenced apparatus, system, and method may employ an ebb and flow, table-based water system that may be stacked above and below other alike flooded tables, as shown in the example of FIGS. 1, 2 and 3. As illustrated in FIGS. 1, 2 and 3, the present invention is comprised of numerous basic components: a water-based nutrient bath 10 resident in a tank 12 having a given volume, such as at least 250 gallons, wherein included within the substantially environmentally sealed tank is a pump 14 for pumping the nutrient rich water from the tank 12 up to each level of the high-density tables 20, preferably on the same (and a single) side of each table, and an out-flow system for each table comprised of an anti-block drain or drains 24 whereby the water flows across the table and down the drain(s) based on the pull of gravity, and may flow back into the minimum 250 gallon tank that includes the nutrient bath.

Each of a plurality of multi-level flow tables 20 in which crops are grown may comprise between two and eight levels, such as vertically atop of the other, made up of, for example, 6-10 foot long water tables, such as 8 foot water tables; a lighting system 40 that provides light above and in close but not overly close proximity to each of the multi-level flow tables 20, wherein the lights may comprise, by way of example, induction or LED lighting and that may be moved across and/or down the table. Further included may be, by way of example, a floating base “float” 44 within each table, such as may be comprised of foam, wherein the floating base may be any substance suitable to float atop the water flowing from one side of each table to the other, and/or to absorb and/or otherwise insulate crops from the heat from the lighting 40.

As described, the present invention may be adapted, based on adjustment of the nutrient bath and lighting, to accommodate growth of nearly any particular crop 102. For example, it is well known in the hydroponics field that for every 5-10 degrees above 70 degrees Fahrenheit that the water/plant roots are heated, oxygenation to the plant may be cut by up to half. It is for this reason that, in the known art, the use of induction lighting is typically avoided. However, the use of the heat absorbing float in the present invention allows for the use of induction lighting, and minimizes the need to make significant adjustments in the proximity of the lights and the temperature of the water for various different crops.

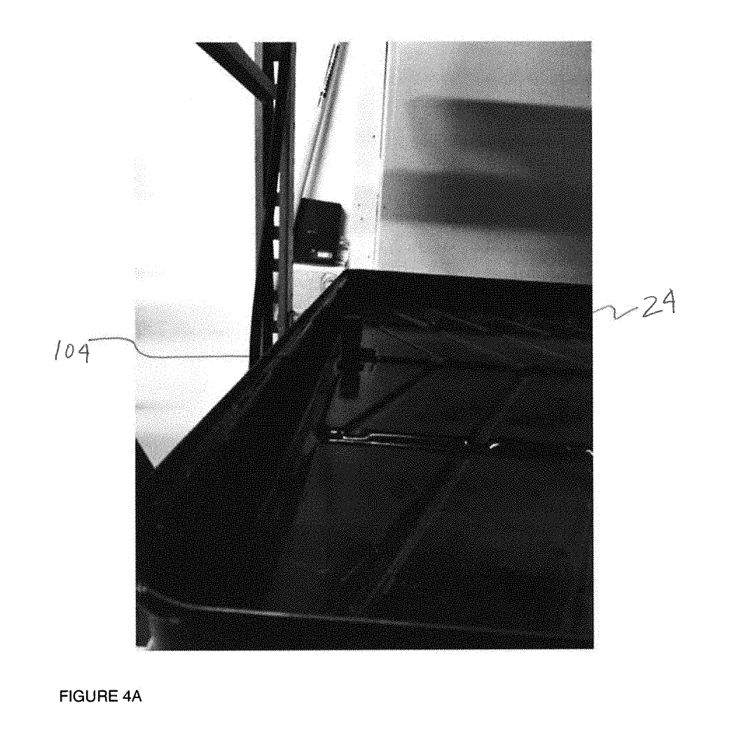

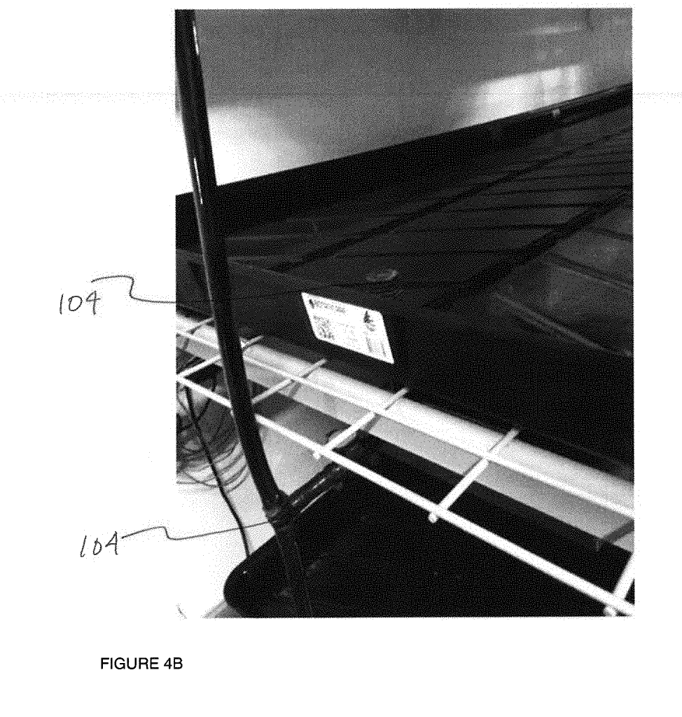

Each table may be standardized size of flow table 20 as is known in the pertinent art, and as is shown with particularity in FIGS. 4A and 4B. For each table 20, as shown, an inlet 104 may reside on one end of the table, and water may be turbulently “bubbled” up through that inlet 104 into the table 20, whereafter the water disperses and flows across the table to the other side of the flow table, at which point a single drain or multiple drains 24 may receive the water and allow flow of the water down the other side of the flow table, i.e., at the other side of the multi-level farming stack, back to the tank. The water bubbled up from the tank may preferably be relatively cool initially, and may remain so due to the insulation of the water from the lights performed by the floating foam when the water returns to the tank, and/or from temperature controls on the water within the tank.

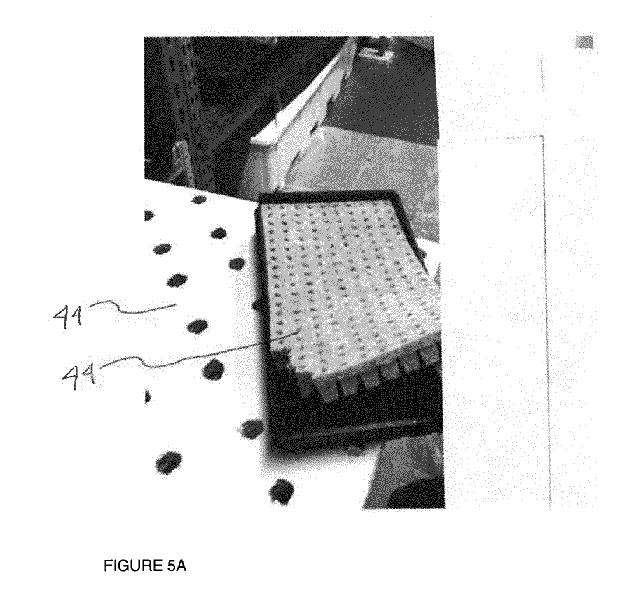

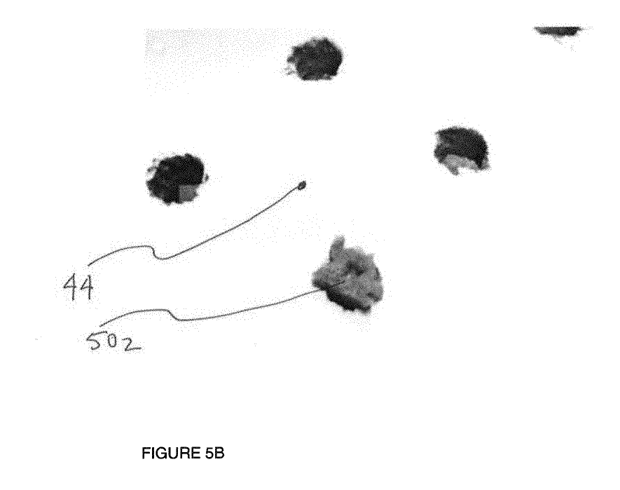

FIG. 5A is an illustration of optional floats 44, such as may be based on table size, for floating atop the nutrient water in a flow table. Of note, each flow table may include one or more floats as may most readily allow for scaling of crops grown in each flow table. Thus, for example, each float may be readily modifiable, such as being easily cut, to provide any desired density for particular plants to grown within the float. As mentioned herein, each float may comprise, for example, foam, and may be of a suitable thickness, such as between 1 and 4 inches, to suspend a growing plant at the desired height above the water and to sufficiently insulate (and or cause a “stretch” between) the plants roots and the nutrient water from the heat provided by overhead lighting, such as the induction lighting referenced herein.

Moreover, and as is illustrated in FIGS. 5A and 5B, each plant seedling may be initially grown in, by way of non-limiting example, rock wool 502, also known as volcanic rock wool, to improve germination of each plant. Accordingly, when each plant reaches a desired height, it may be readily replanted within the float 44, assuming that each hole in the float has been cut to size to receive the size of the rock wool in which the germinated seedling resides. This, too, is clearly illustrated with respect to FIG. 5B.

Accordingly, the present invention provides a simple and scalable multi-level hydroponic farming system, wherein broad spectrum lighting, such as induction lighting, may be used without overheating plants, and wherein floats may be employed of any desired depth and density to optimize yield on a crop by crop basis. Moreover, the height of each flow table, and its distance from the lighting system, may preferably be adjustable, such as by a simple pulley and catch or manual adjustment shelving system. The number of platforms, the depth of the float, and the distance from the lighting system for each crop may be entirely adjustable based on the crop being grown.

Thereby, crops may be grown in almost any indoor farm setting, including in a “flash farm” or “artisan farm” context. That is, multi-level farming may be performed in spaces ranging from 32 sq. ft., that is, the size of a standard float and shelving at a single level, up to 10,000 sq. ft. or more. This artisan farming requires no special skills, and allows for, for example, restaurants to engage in their own farming of crops used, and further for farming to be readily available even in urban areas where space is at a premium. In an exemplary density, 60 float tables may thus be provided, wherein each float table may be 8 ft. by 4 ft. and as little as 1,600 sq. ft. of space.

Yet further, the non-use in the present invention of pesticides or animal waste allows for heightened cleanliness of the food growing environment. Thus, for example, various restrictions typically employed in electronics clean rooms may likewise be employed in the instant invention to maintain the cleanliness of the present farming methods. For example, various methods may be employed to keep out bugs, growth centers may be outside food-free, cleanliness may be optimized, airlocks may be provided at entry and exit and kosher food protocols may be followed. Of course, the simplicity and scalability of the instant invention also allows for improved cleanliness and maximum crop yield without engaging in the aforementioned clean room protocols.

As mentioned, farming may thereby be performed even in urban areas, or within businesses, such as restaurants. Accordingly, artisan famers may engage in their own farming and/or may license the right to employ the apparatuses, systems and methods discussed herein. Similarly, businesses may engage in farming on site, and may hire third parties to come in and service the farm on an as-needed basis, or at predetermined intervals, in a manner akin to office coffee service replenishment systems that are known in the art.

Various advantages are provided in accordance with the described apparatuses, systems, and methods. For example, inclusion of a cut-off point detector in each tray for the float level allows for the prevention of flooding if the float rises to too high a level. Such float cut-off switches may be very simple mechanical switches, unlike flooding prevention switches that are needed in the current art, which are far more complex. Moreover, as mentioned above, the absorption of heat by the provided floats allows for the use of broad spectrum lighting, such as induction lights, which provide for improved plant growth for other than flowering plants as compared to LED lights.

Additionally, as a further advantage, the instant invention uses 98% less water than standard farming systems. This is due to the recycling of the water, the enlarged size of the tanks and the substantially sealed nature of the tanks. Because only the plant and evaporation can remove water from the disclosed invention, minimizing evaporation through the relative sealing of the tanks, in conjunction with the increased size of the tanks, minimizes the need to add nutrients or water to the system as frequently as is the case in the known art.

As an additional distinct advantage, the number of human “touch points” in the instant system is appreciably below the known art. Generally, even in hydroponics systems known in the art, the number of human hands that touch food during the growth and processing processes is immense. This leads to Ebola and other food borne diseases. However, in the disclosed invention, each plant is touched only twice, when implanted in the rock wool, and when removed from the rock wool. Cleaning is unnecessary, due to the heightened clean state of growth. Movement or adjustment is unnecessary due to the nature of the lighting system and the float system disclosed herein.

Moreover, a distinct advantage is the exceedingly high density provided by the current invention, in part due to the clean nature of the growth process, and in part due to the larger tanks in the watering system. This high density growth allows for growth in urban areas, which, in the event of a disaster, allows for the availability of food at the point of necessity, without need to bring food from the outside. Moreover, this increased density allows for an increase of over 200 times the traditional farm density—that is, using the disclosed invention, a 15 acre farm may fit in a warehouse of less than 5,000 sq. ft.

Crops may also be improved through the use of the present invention. For example, because the plant has a balanced nutrient bath, providing nutrients, pH levels and the like specific to that plant, and because water at a proper temperature and air are readily available, each plant need not struggle to grow. Consequently, plant growth, and thus taste and quality, are optimized. Moreover, because the suspension of the plants by the float allows the roots of each plant to “reach out” to the water, a low amount of water is needed, but the plant's growth rate is optimized, and the plant's growth rate is further optimized based on the acceptability of the use of broad spectrum lighting.

The present invention may additionally include flushing and filtering systems for the nutrient bath. For example, because, as mentioned herein, water loss is extremely low, and animal waste need not be employed in the instant invention, the need to flush the water tank system arises only very infrequently, such as every four to five months. Additionally, the reuse of the nutrient baths for extended periods of time prevents any contamination of local water systems. Moreover, the clean state of the baths allows for “plant improvement” stations. That is, in the event a nutrient bath is not providing its subject plants to optimize growth or flavor, those plants may be moved to a cleaning station, such as wherein a different bath is provided to clear out plant salts and improve taste. This movement to the plant improvement station does not require that a human pick up each individual plant, but rather that only the foam float be touched, and the foam float be moved from one station to another, thereby the present invention is thoroughly adaptive to clean plant growth, such as through shelf movement, light changes, foam movement, bath recycling, cleanliness stations, lack of need to flush the system, and end stage filtering for nutrient bath flushes.

The optimization of plant growth throughout provides several benefits. For example, optimized growth provides maximum yield in minimal time, as well as providing crops that grow at such a high rate of speed that the crops reach maturity that prevents attack from bacteria and parasites before the bacteria and parasites have an opportunity to take hold.

In accordance with this optimization, precision growing may be provided through the use of the present invention. That is, control of all factors, such as light, water flow, nutrients within the water, bacteria and parasites, and of numerous other factors, either locally or remotely using the networking aspects discussed herein, allows for the providing of different growth rates to match demand, modification of factors to quickly change desired crops, and the like. Further, such precision growing allows for growth out of cycle with local and remote outdoor farming. Such ability for staggered harvesting reduces crop competition both for the instant invention and outdoor farming.

Moreover, the precision growing discussed herein allows for the separation of water and nutrient supplies from one another, thereby further preventing crop disease and damage. Needless to say, this also further enhances crop yield and health over the known art.

To provide such optimization and precision, the presently disclosed embodiments may also advantageously include novel lighting 44 suitable for the indoor growth of plant life. In the known art, two principle problems occur due to the lighting for indoor growth efforts, as referenced above—the first issue is so called “mounding,” in which plants reach towards the stationary lighting placed above the plants in a misshapen growth pattern. Correspondingly, plant growth and yield is often uneven, and is centered largely only directly beneath the light source. The second problem frequently encountered due to lighting for indoor growth efforts is decreased yield due to scorching, burning, or overheating. That is, the heat from the lights may brown or kill plants closest to the light source, due, in part, to the heat emanating from the light source.

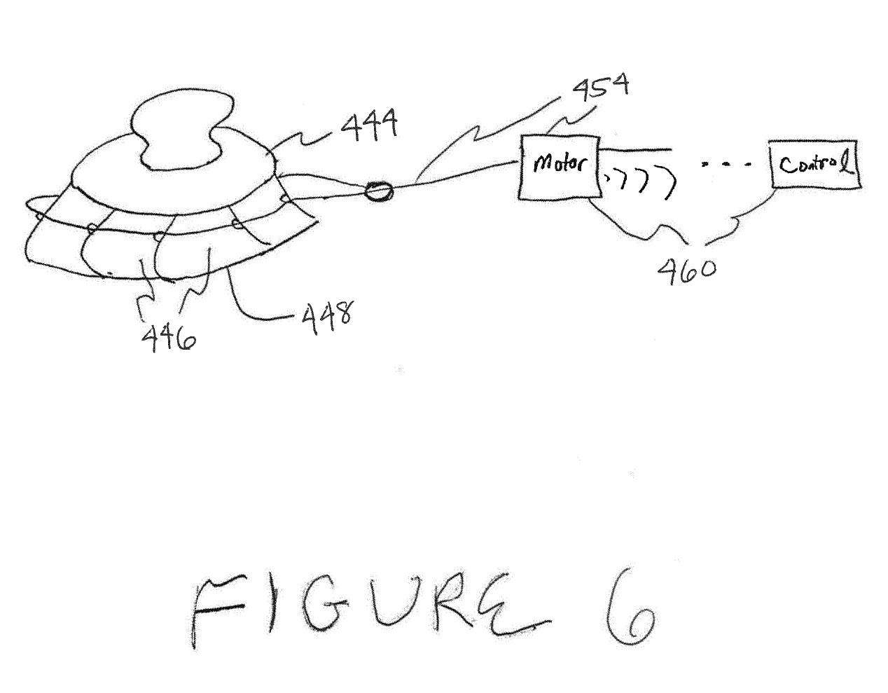

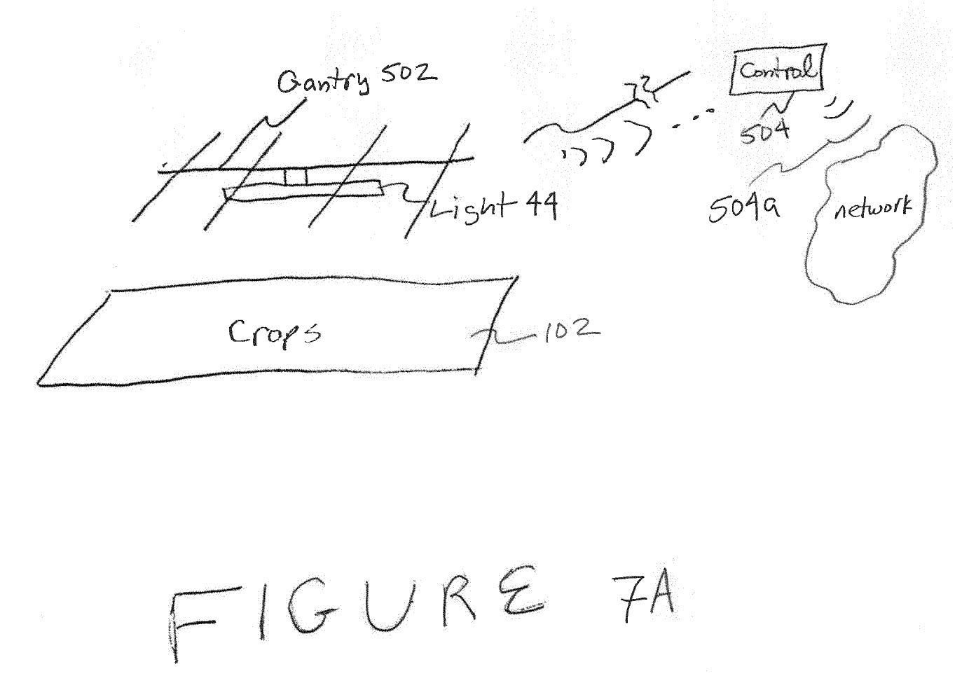

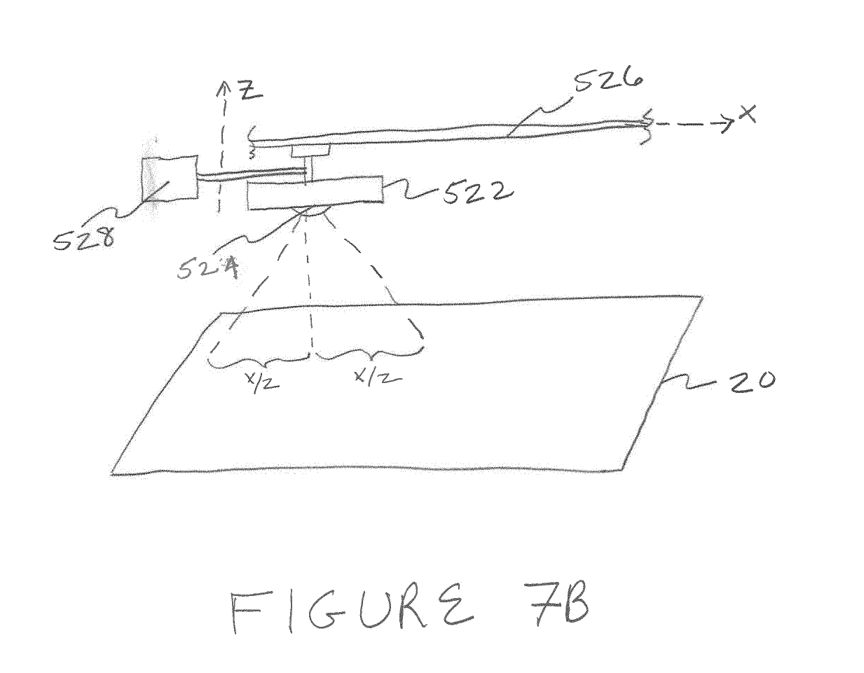

The present disclosure includes a novel light enclosure, and a novel light system. The light enclosure 444 may be that of the exemplary embodiment illustrated in FIG. 6. As illustrated in FIG. 6, the light enclosure 444 may be in the shape of an iris—that is, an enclosure having several overlapping leaves 446, or folds, in which the overlapping leaves are able to slidably increase the aperture 448 of the enclosure, or slidably decrease the aperture 448 of the enclosure.

In embodiments, the opening and closing of the enclosure aperture 448 may be mechanically actuated 454, such as by one or more flexible cables looped about the leaves of the aperture. This cabling may be looped, for example, through an eye on one end of the cable line, wherein the other end of the cable which is looped through the end having the eye is associated with one or more mechanical gears. Upon actuation, such as part of an actuation system 460 that may include a motor, these gears may pull the cable tighter through the eye, thereby closing the aperture 448 of the enclosure to a desired degree, or these gears may reverse and provide additional slack in the cable, whereby the aperture of the enclosure may open. Accordingly, the aperture of the enclosure may be suitably adjusted for any number of factors, such as light to be provided to a crop, distance of the light enclosure from a crop, motion of the light in relation to a crop, heat provided by the light or to the crop, or the like.

Moreover, in exemplary embodiments one or more internal features of the enclosure, i.e., that portion of the leaves of the enclosure that are immediately adjacent to the light source, may be reflective and/or refractive. By way of non-limiting example, the interior of the enclosure aperture may be 95-98% reflective, such as in order to best direct the light from the light source through the enclosures aperture. Additional modifications may be provided, such as wherein the light source, such as a light bulb, is oriented perpendicularly to the plane in which the crops are grown beneath the light source, thereby providing maximum reflection of the light source from the reflective internal sides of the aperture enclosure.

Thereby, the light source may be lower power than is known in the art, thereby decreasing the cost of the light source as well as the likelihood of crop burning due to the heat provided from the light source. In an exemplary embodiment, a typical light source may be in the range of 100-500 watts, and most preferably may be about 320 watts.

FIG. 7A illustrates a system diagram of a system in which a light 44, such as the iris enclosure 444 of FIG. 6, is provided in a movable fashion adjacent to the crops. By way of non-limiting example, FIG. 7A illustrates a mechanical gantry 502 along which the light source 44, such as the enclosure 444 of FIG. 6, may move. The moving of the light may be in a predetermined pattern, for example, dependent upon crop type, and may be controlled by, for example, on or more automated control systems 504 (which may be the same or different than control system(s) for the opening of the light aperture, etc.). Such control systems may be, for example, one or more local programmable logic controllers, which may be associated with one or more local or remote network controllers.

FIG. 7B illustrates an additional embodiment of a novel lighting system 520 according to the embodiments. As illustrated, the lights 522 may have an illumination distance X of, for example, approximately four feet from the center of the light source 524, and may traverse in an automated, predetermined, and/or timed fashion along the X-axis 526. Further, the lights may be equipped with a manual or automated Z-axis adjustment 528, whereby the lights, and particularly the X-axis along which the lights move, can be raised and lowered, in whole or in part, manually or automatically.

As will be understood to the skilled artisan, if the lights hang too low, or are too stationary, too much heat may be provided per plant, thereby damaging or killing the plants. Thereby, moving the lights and ensuring that the lights are a proper height from each particular plant prevents over delivery of heat to the plant, while optimizing light delivery to each plant. Further, maintaining water temperature at a low value may help minimize adverse effects of lighting on the plants.

Remote control of the lights, such as via at least one network, may allow for purchase by a grower, lease to a grower, or provision to a grower using a “light subscription”. In a subscription based model, a purchaser may receive lights akin to those disclosed herein, wherein the purchaser may pay for the amount of light used, or may pay for the value of the lights themselves over time, wherein the lighting may be tracked using, for example, the network communications of the lighting system disclosed herein. Moreover, a provider of the lights to the lease may insure against the loss of the lights, and may additionally monitor the use of the lights for compliance with a subscription agreement. Yet further, financing may be provided pursuant to a leasing or subscription model.

Thereby, the networking capabilities 504a of the present invention may allow for both financial and insurance models to be employed in the instant invention. It further may allow for remote monitoring and programming, such as to match lighting to a particular crop, or to monitor for acceptable operation of the lights or to prevent damage to crops.

Additional features might be added to both the motion aspects and the light providing aspects of the instant invention, such as in order to optimize crop yield. For example, motion algorithms may be modified over time as optimal motion is learned, such as via the aforementioned monitoring, for particular plant types. Additionally, features such as a randomizer may be added to avoid hot spots that may damage growing crops.

Moreover, because the lighting controls may be wirelessly networked and may thus be capable of wireless communication, the network may provide for additional sensing, such as including light temperature and room temperature. Moreover, wireless lighting controls may allow for the creation of a mesh network using the lighting controls, which may additionally allow for control of individual light aspects via one or more wireless technologies, such as via a mobile device app.

Additional features may improve crop yield and general operability of the instant invention, such as in conjunction with novel lighting 444. For example, enhancing the turbulence of the cross flow across a growth bed/table 20 may provide optimal re-oxygenation of the water flow. In such embodiments, multiple drains 24 may be provided to accommodate said cross flow, wherein safety shut off valves may be provided in association with one, some, or all drains to prevent drain jamming and flooding.

By way of example, between 9 and 11 drains may be provided, such as in a staggered manner, to ensure that some water is maintained at a proper minimal level such that it enhances plant growth, but additionally in order to provide best for the prevention of overflow. The drains may operate as venturi drains, i.e. as siphons, thereby maximizing oxygenation of the water.

Not only does the aforementioned high oxygen content of the water provide optimal plant growth, but further the multiple drains forcing the plant roots to “stretch” towards the water provides aeroponic growth and optimizes plant health, as discussed further herein below. Yet further, the multiple drains that allow for high flow and high turbulence break up anaerobic bacteria, i.e. scum, thereby optimizing crop yield and plant health.

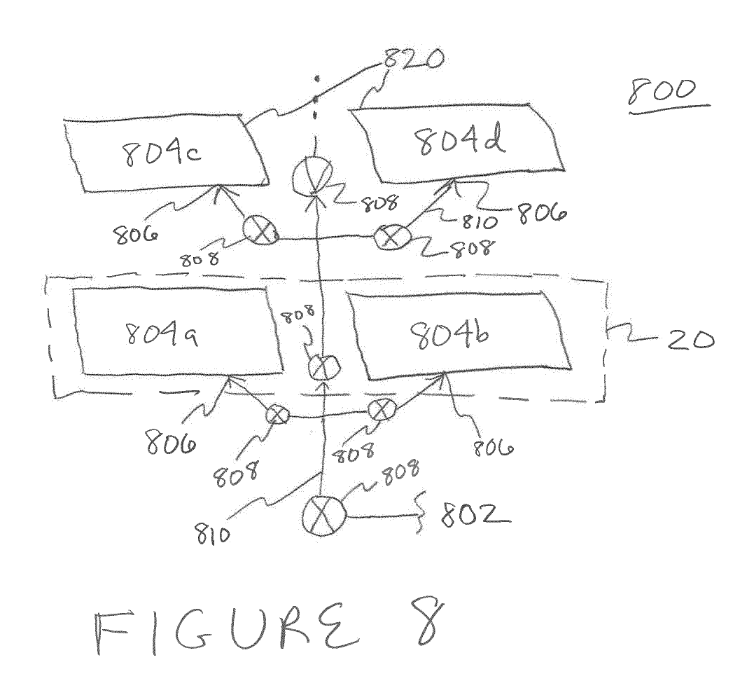

In order to optimize and aid precision growing, the embodiments may additionally include a highly modularized system of both water supply 802 and growing trays 804a, b, c, d. More specifically, FIG. 8 illustrates a partial rack of 4-foot by 4-foot growing trays each on approximately eight foot table shelf 20. As will be understood, each shelf of two trays thus provides a 4-foot by 8-foot growing area, with each pair of growing trays providing modularized units. Further, and as shown, each 4×4 tray is provided with valved water inlet 806, i.e., two valves and two inlets per shelf in the current example, and each shelf 20 in the rack may additionally be provided with one or more valves 808. Thereby, water supply to each tray, each shelf, or sets of shelves may be activated or deactivated by optionally opening or closing individual valves. As such, a growing unit, such as an 8-foot rack having four shelves 20, may be modularly deployed or deconstructed.

Accordingly, pipes, such as PVC pipes 810, that supply the water for each tray needn't be glued together, but instead may be threadedly or via compression connected and disconnected from a corresponding inlet, valve or valves 806, 808. Thereby, modules, such as including pipes, trays, and so on, may be swapped in and out of the system 800 in real time, such as for cleaning and re-swapping at a later point in time, such as monthly. Such maintenance may be performed in, for example, one hour or less. Further, the disclosed modularity may allow for construction of an eight foot rack of shelves 20 in approximately one to three hours or less. Yet further, the lack of glue needed to seal pipes avoids the growth of anaerobic bacteria, thereby improving plant health and growth rate.

Due to the modular nature of the disclosed embodiments, cleaning of pipes and/or trays may be done in common dishwasher, using peroxide based cleaning, or with simple water steam, by way of non-limiting example. This may allow for in situ cleaning of certain modular aspects of the system, due to the ability to effectively disconnect preselected modules from the water supply.

The placement of each tray or pair of trays 820 per shelf on one or more low profile pallets may allow for ground based harvesting, which is an additional efficiency provided by the disclosed system modularity. For example, a low profile pallet may be fork lifted to ground or table level in order to plan or harvest each individual 4×4 modular tray, such as after any water supply has been disconnected from the respective tray. As such, in a first step a given tray or trays may be disconnected from the water supply using the disclosed valves, which consequently allows for the water in the tray to empty. As a second step, a forklift may then be used to move the pallet upon which a respective tray rests to a harvest or planting table. After harvesting or seeding occurs, the same forklift may lift the low profile pallet and modularly replace the tray, at which time the water supply may be reconnected and water may flow. As such, harvest and plant teams may be uniquely created, and downtime for harvesting or planting may be on the order of minutes rather than hours, while the risk of falls, ladders, and the attendant risks in using scissors lifts and the like is avoided.

Thereby, the disclosed embodiments may provide hot swappable, i.e., scalable and/or fully modular, closed indoor farming systems. That is, the disclosed modules may come on and off independently in a single device, thereby providing scalability and team-based, highly efficient indoor farming.

Further and to optimize and provide process refinement, the disclosed embodiments may provide unique piping in the modular aspects of the embodiments. The unique piping may allow for enhanced flow, such as to allow full water exchange on all trays of a full rack in one to two minutes or less, which all but precludes the growth of anaerobic bacteria.

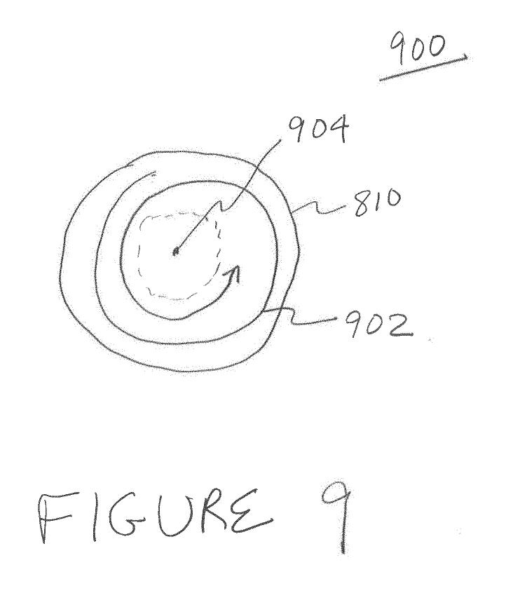

More particularly, the piping 810 of the disclosed embodiments may allow for the creation of a Venturi pressurized system 900 as illustrated in FIG. 9. In short, the providing of multiple drains per 4×4 tray, such as 2 to 12 drains, or more specifically such as 10 drains, allows for increased water flow across each tray. This increased water flow, upon reaching downward drain piping, creates a multiplicative spiral 902 within the pipe as illustrated in FIG. 9. This multiplicative spiral 902 enhances the surface area on the outside of the flow and creates an air pocket 904 in the center of the pipe as shown, thus creating a Venturi flow that exposes more of the water to oxygen, thereby enhancing the amount of oxygen that enters into the water. This oxygenation of the water may be further enhanced by, for example, pressurizing the water in the pumping base tank (as discussed above) with additional oxygen, and/or increasing the turbulence of the water in the base tank, such as with fans or blowers, by way of non-limiting example.

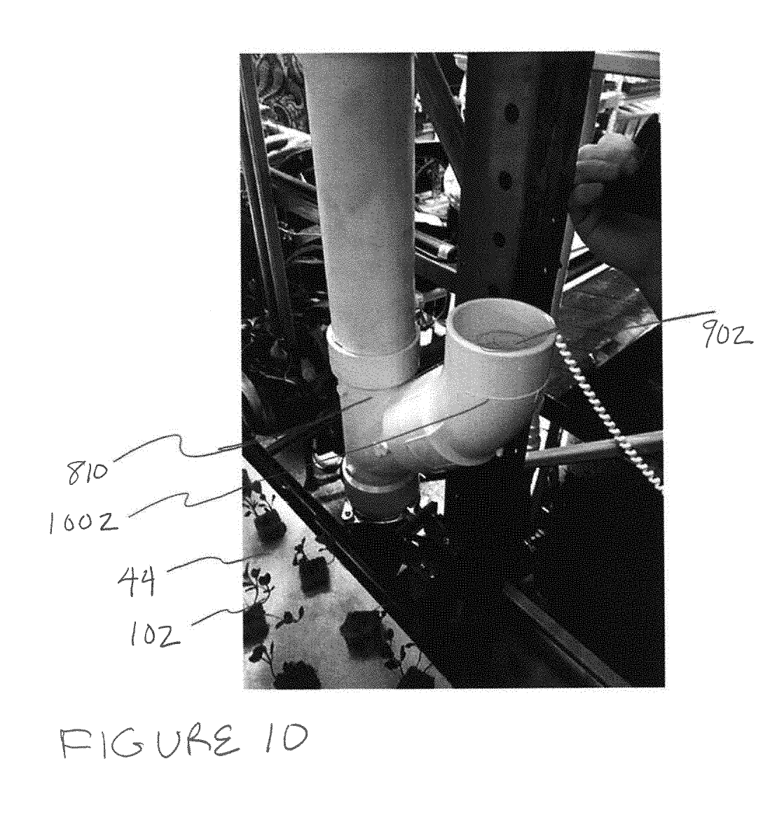

Correspondingly and as illustrated in FIG. 10, the modularity of the piping 810, in conjunction with the Venturi flow within the downward pipes, may readily allow for the location of high-mixing nutrient inputs 1002 along the downward piping, such as whereby nutrients may be readily entered into a nutrient input, mixed by the Venturi flow for entry into the tank, and subsequently pumped back upwards into each modularly operable tray.

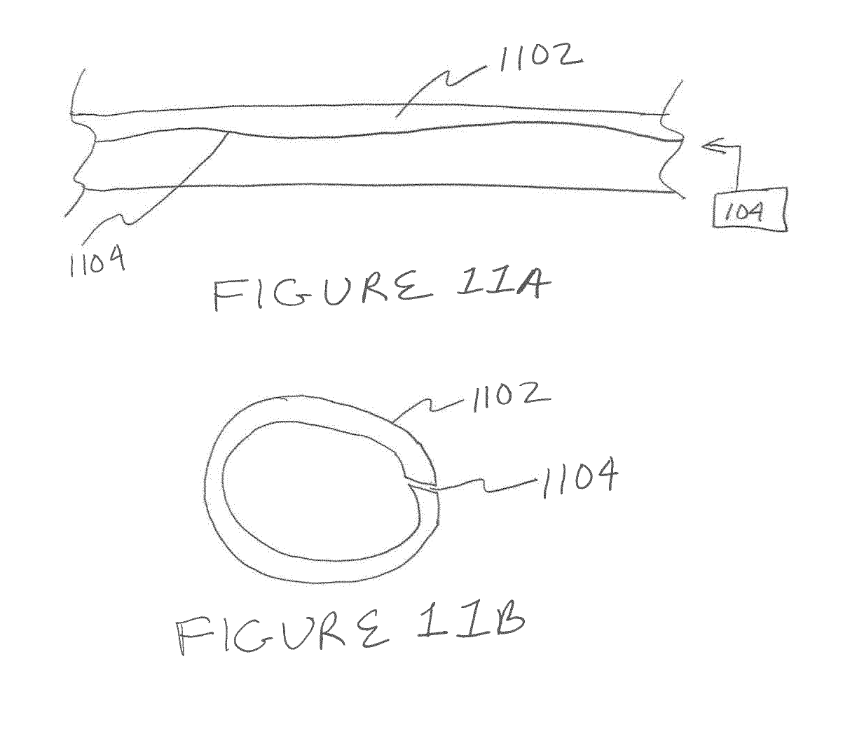

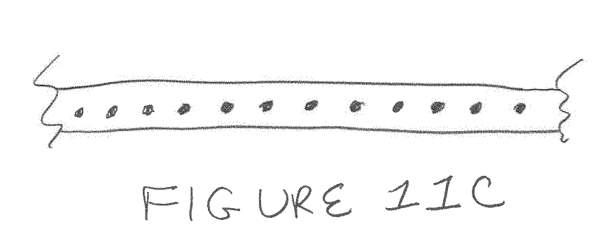

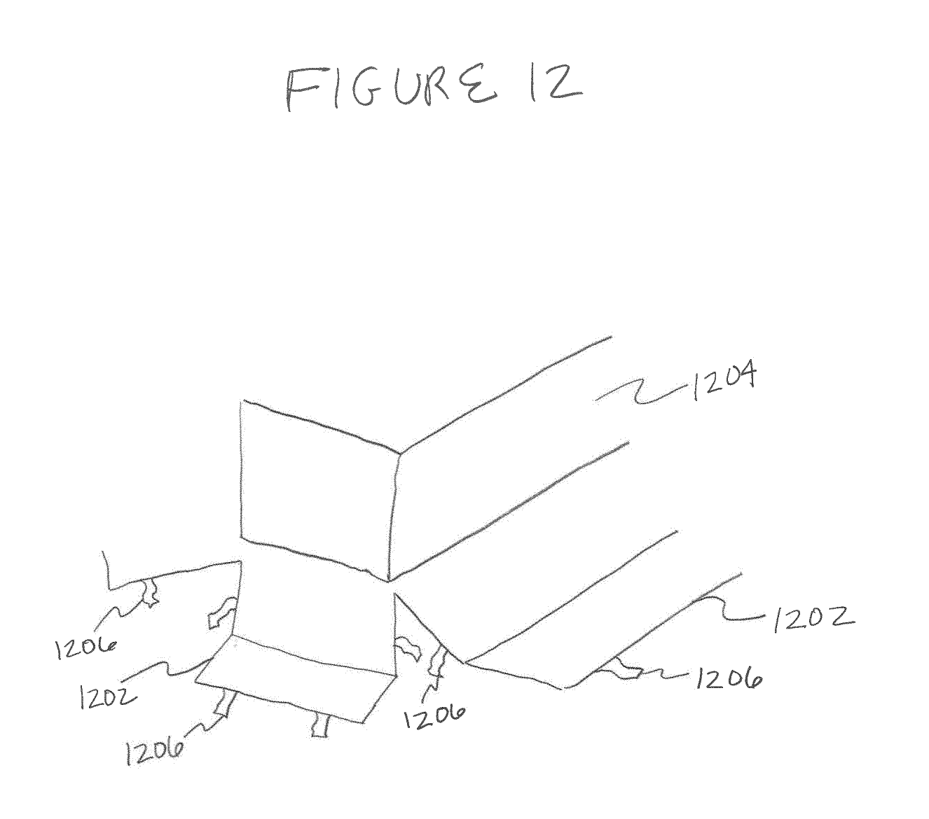

Additionally and as illustrated in FIGS. 11A and 11B, novel and modular spray bars for providing water from the water inlet 104 into each tank may be provided according to the embodiments. These spray bar inlets 1102 may, in some embodiments, have a slit 1104 running lengthwise and at one or more tangent points on the circumference of the spray bar 1102. More particularly, this slit 1104 may run the full or partial length of the spray bar, may or may not be uniform from the center point of the mean high water line on the pipe along the length of the spray bar, and may or may not be comprised of a uniform cut or cuts, both in cut size and/or cut angle, along the length of the slit.

The novel spray bars 1102 of the disclosed embodiments stand in stark contrast to other embodiments, such as that illustrated in FIG. 11C, and, because a uniform water spiral is created within the pipe prior to exit of the water from the slit 1104, water flow uniformity across the tray is enhanced, while increased turbulence is created in the flow within the pipe to additionally enhance the water content of the water flowing across the tray.

Further and by way of non-limiting example, maintaining the water in supply tanks at a low temperature, such as 68°, may further prevent overheating of plants, including by serving as a heat sink for the room. To minimize the possibility that the water temperature will be undesirably raised, FIG. 12 illustrates a tank cover 1202 that may protect the tank 1204 from gaining or losing heat, and that may be comprised of heat reflective material, such as that included in oven mitts. The tank cover may additionally have Velcro, or a like ready-fastener/unfastener 1206, to allow for simplistic attachment of the cover to the contours of the tank, and which may further allow for simplistic removal of the cover from the tank, such as to allow for washing of the cover.

The controls and sensing discussed throughout may further include optimization of the enthalpic moment for the growing environment. That is, the embodiments may, using each individual plant and algorithms specific to certain plants and environments applied by one or more computer processors, provide an optimized window of a plant's needs for optimized growth. In short, an optimized enthalpic moment may have a large number of contributing variables, but principal among these variables are water (which includes bacteria and nutrients), CO2, and light. Through assessment of variables correspondent to at least the foregoing three, and, in preferred embodiments, additional variables, the algorithms may correlate the variables over a particular range to obtain an enthalpic moment of optimized growth for individual plants. Such calculations may additionally include, by way of example, the energy provided by manual laborers typically present in a room, energy provided by computers in a room, energy produced by light wattage, energy or gases absorbed by enhancing turbulence in water flow, and the like.

Manipulation of variables to obtain an optimal enthalpic moment may allow for minimization of the use of heating or air conditioning in a given environment. For example, in light of a plant's needs, variables may be controlled with a target point for environmental temperature and humidity. Maintenance of temperature and humidity at a preferred steady state, while providing at least minimum quantities of water, CO2, and light, may optimize plant yield and minimize failures.

Accordingly, while sensors may be used to provide to one or more computer processors applying the disclosed algorithms a current state of each of the variables discussed herein, environmental definition and control may be modified from the known art. For example, environmental controls may be defined by an enthalpy factor, wherein the environment is to be maintained for optimal plant growth within a particular tolerance of a given enthalpy factor for the growing then underway.

Further, the use of an enthalpy factor allows for the definition of an energy value on a per plant basis to maintain a given enthalpy factor. Such energy value may include, by way of non-limited example, the capture of heat by each plant from one or more lights to which the plant is subjected, the effects of sunlight on energy consumption on a per plant basis if lights are only used periodically or at night, and stray energy within a room that may be captured and rededicated to plant growth.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

Moreover, it can be seen that various features may be grouped together in a single embodiment during the course of discussion for the purpose of streamlining the disclosure. This method of disclosure is not to be interpreted as reflecting an intention that any claimed embodiments require more features than are expressly recited in each claim that may be associated herewith.

What is claimed is:

1. An indoor farming system, comprising:
a water-based nutrient bath resident in a tank;
a pump for pumping the bath from the tank upwardly through a plurality of pipes to at least one divided high-density table comprising growing crops resting in at least one float;
the plurality pipes comprising at least one valve suitable to shut off the bath per each of the high density tables;
at least one non-block drain on each divided one of the tables, wherein the bath turbulently flows respectively across each of the divided tables and down the at least one non-block drain based on at least gravity, and then back into the tank that includes the nutrient bath; and
a lighting system that provides moving light from points above the growing crops.
